(19) United States
(12) Patent Application Publication
(10) Pub. No.: US 2007/0094245 A1
(43) Pub. Date: Apr. 26, 2007

(54) Computer-implemented system and method for obtaining customized information related to media content

(76) Inventor: Frank J. Vigil, Stanford, CA (US)

Correspondence Address: James H. Salter, 105 Thoreau Lane, Folsom, CA, 95630, US

(21) Appl. No.: 11/254,530

(22) Filed: Oct. 21, 2005

(51) Int. Cl. G06F 17/30

(52) U.S. Cl. 707/4

(57) ABSTRACT

A computer-implemented system and method for obtaining information related to media content is disclosed. The present invention relates to a computer-implemented method including: inspecting a user dataset to obtain a list of media content items, extracting characteristic information and metadata from media content items, optionally enhancing metadata by obtaining more metadata based on the characteristic information, optionally obtaining filtering preferences from the user; and using at least a portion of the content metadata and the filtering preferences to obtain related event information from an external source.

### BACKGROUND

1. Field

Embodiments of the invention relate to the field of computer network applications and networked communications; and more specifically, to the field of media content information obtained via a computer network.

2. Related Art

The growth of the commercial Internet has provided a platform for new methods of electronic commerce. There are wide and varied models for implementing electronic commerce on the Internet. One type of model of electronic commerce involves developing correlations between products. These product correlations are used by product vendors to suggest related products to purchasers. For example, U.S. Pat. No. 6,912,505 assigned to Amazon.com describes a computer implemented products identification method involving the mapping of each product to a respective set of related products, such that product relationships reflect correlation between product viewing events. Using this technique, Amazon.com can suggest related products to a consumer based on previously viewed or purchased products. In other prior art systems, a music or video vendor can suggest related music or video media to a consumer based on the consumer's previous purchases of other music or video media. These prior art systems, however, only provide correlations between relatively homogenous types of products or content. These systems do not extend the correlation to other types of related information a user may find useful. U.S. Pat. No. 6,757,691 describes a method for predicting content choices by searching a profile database. This method manages a user's choice of television programs using a stored psychographic profile of a user to present only programs containing content predicted to be of interest. This provides a user customized viewing experience but the user-specific information is only based on a stored user profile.

Other prior art systems are related to search engines or searching techniques. In these systems, a user-submitted query can be searched more efficiently using user-specific information retained from previous queries. In some cases, a user profile can be used to further refine and improve the generation of search results for a particular user. For example, U.S. Pat. No. 6,185,558 describes a system for identifying the items most relevant to a current query based on items selected in connection with similar queries. In another example of prior art search technique, U.S. patent application number 20050160083A1 describes a search engine that receives a search query and performs processing to determine whether a user-specific search is indicated. If the search engines so determines, user-specific data is searched using user identity information to generate user-specific search results specific to the user identified by the user identity. Again, these prior art systems draw correlations between various search queries; but, the correlations are limited to a search domain.

In other prior art systems, visual content, including interactive content, may be delivered over an online service in such a way that it is synchronized to the delivery of content from a musical recording. In this manner, correlations between musical content, for example, and video content, for example, have been made and used to deliver one type of content to a user, while the user is consuming a different type of content. For example, U.S. Pat. No. 6,154,773 describes a network delivery system that can deliver interactive entertainment complementing audio recordings. In this system, entertainment content complementary to a musical recording is delivered to a user's computer by means of a computer network link. The system further retains data representative of a user's listening habits relative to a record company's CD (audio media). This data is transferred to the record company when complementary content is delivered to the user over a network connection. In this manner, video content can be delivered to a user when related musical content is being consumed.

Though these prior art systems maintain correlations between products or content items, prior art systems do not inspect a user dataset to obtain a list of media content items to augment user-specific information. Further, prior art systems do not extend data correlations beyond specific types of content or products. As such, prior art systems cannot provide other types of related information that may be useful to a user. Prior art systems cannot obtain related event information from an external source based on user-specific information. Prior art systems also cannot present available related information to a user and retain a notification request for related information that becomes available in the future, so the newly available information can be presented to the user.

Thus, computer-implemented system and method for obtaining information related to media content is needed.

### BRIEF DESCRIPTION OF THE DRAWINGS

The present invention is illustrated by way of example and not limitation in the figures of the accompanying drawings, in which:

FIG. 1 is a block diagram of a network system on which the present invention may operate.

FIGS. 2a and 2b are a block diagram of a computer system on which the present invention may operate.

FIG. 3 illustrates a system diagram of the structure used in an embodiment of the present invention.

FIG. 4 illustrates a detail of the structure of the related information link component.

FIGS. 5-9 are flow diagrams illustrating the processes used with various embodiments of the present invention.

### DETAILED DESCRIPTION

A computer-implemented system and method for obtaining information related to media content is disclosed. In the following description, numerous specific details are set forth. However, it is understood that embodiments of the invention may be practiced without these specific details. In other instances, well-known processes, structures and techniques have not been shown in detail in order not to obscure the understanding of this description.

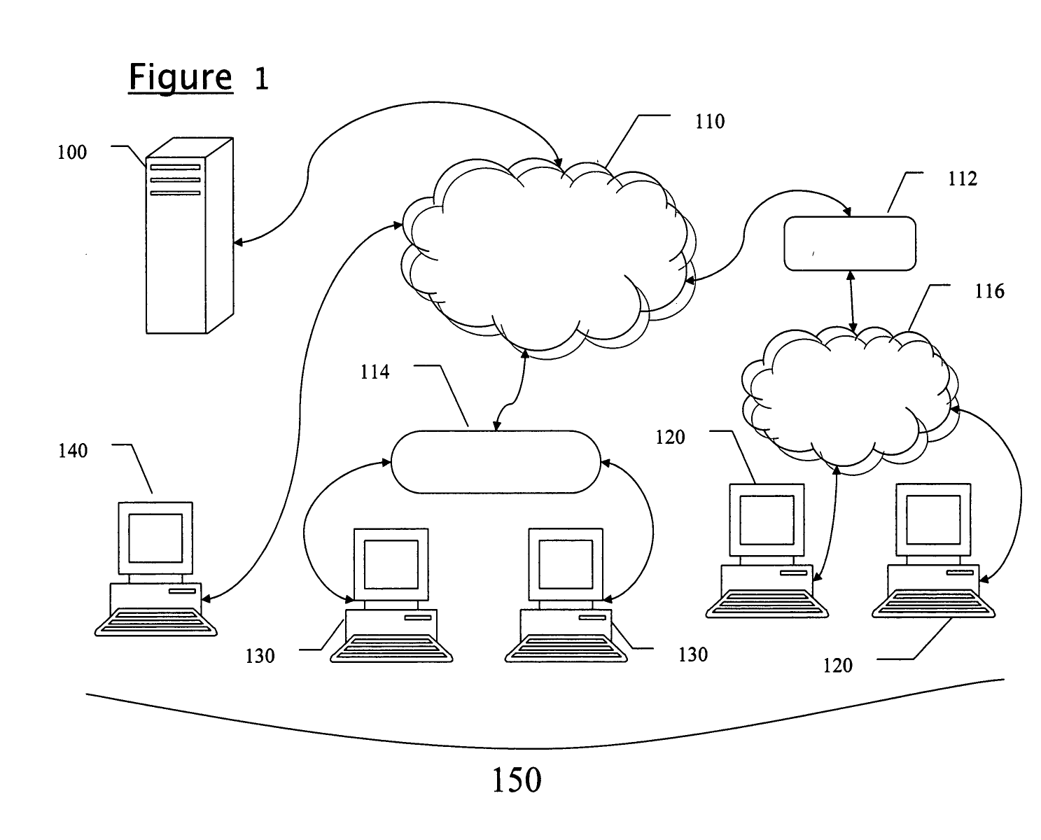

Referring now to FIG. 1, a diagram illustrates the network environment in which the present invention can operate. In this conventional network architecture, a server computer system 100 is coupled to a wide-area network 110. Wide-area network 110 includes the Internet, or other proprietary networks, which are well known to those of ordinary skill in the art. Wide-area network 110 may include conventional network backbones, long-haul telephone lines, Internet service providers, various levels of network routers, and other conventional means for routing data between computers. Using conventional network protocols, server 100 may communicate through wide-area network 110 to a plurality of client computer systems 120, 130, 140 connected through wide-area network 110 in various ways. For example, client 140 is connected directly to wide-area network 110 through direct or dial-up telephone or other network transmission line. Alternatively, clients 130 may be connected through wide-area network 110 using a modem pool 114. A conventional modem pool 114 allows a plurality of client systems to connect with a smaller set of modems in modem pool 114 for connection through wide-area network 110. In another alternative network topology, wide-area network 110 is connected to a gateway computer 112. Gateway computer 112 is used to route data to clients 120 through a local area network (LAN) 116. In this manner, clients 120 can communicate with each other through local area network 116 or with server 100 through gateway 112 and wide-area network 110.

Using one of a variety of network connection means, server computer 100 can communicate with client computers 150 using conventional means. In a particular implementation of this network configuration, a server computer 100 may operate as a web server if the Internet's World-Wide Web (WWW) is used for wide area network 110. Using the HTTP protocol and the HTML coding language across wide-area network 110, web server 100 may communicate across the World-Wide Web with clients 150. In this configuration, clients 150 use a client application program known as a web browser such as the Internet Explorer™ published by Microsoft Corporation of Redmond, Wash., the user interface of America On-Line™, or the web browser or HTML renderer of any other supplier. Using such conventional browsers and the World-Wide Web, clients 150 may access image, graphical, and textual data provided by web server 100 or they may run Web application software. Conventional means exist by which clients 150 may supply information to web server 100 through the World-Wide Web 110 and the web server 100 may return processed data to clients 150.

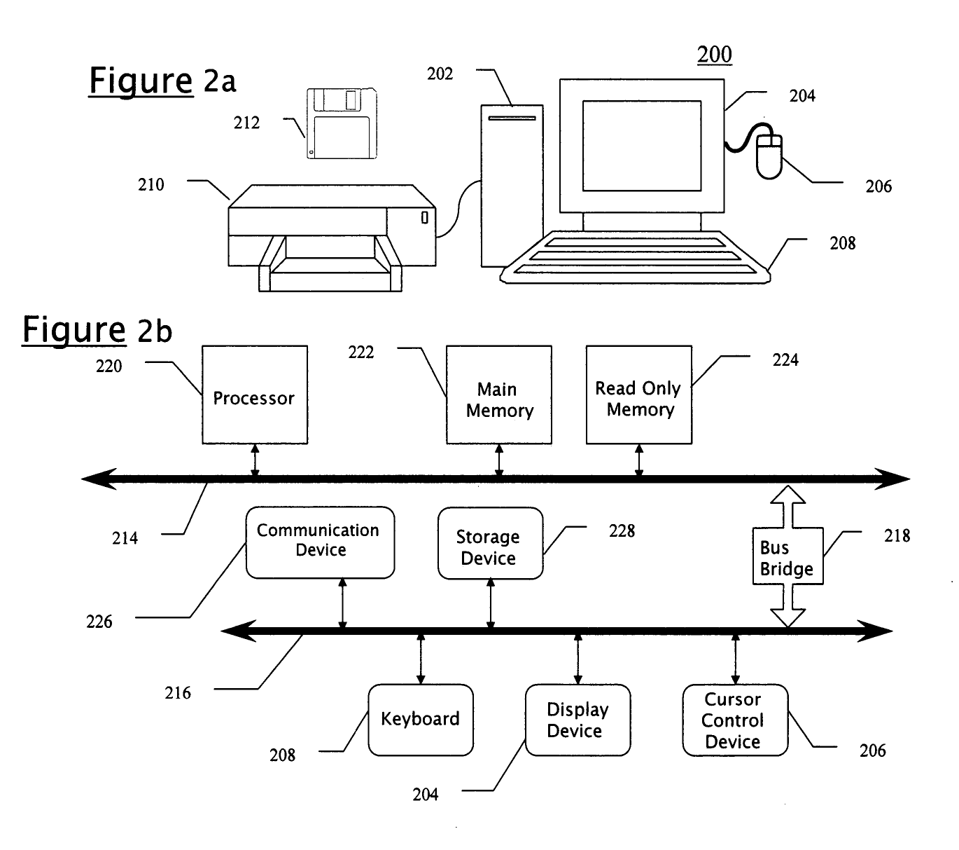

Having briefly described one embodiment of the network environment in which the present invention may operate, FIGS. 2a and 2b show an example of a computer system 200 illustrating an exemplary client 150 or server 100 computer system in which the features of the present invention may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and/or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 150 can be implemented as a network computer or thin client device. Client 150 may also be a laptop or palm-top computing device, such as the Palm Pilot™. Client 150 could also be implemented in a robust cellular telephone, where such devices are currently being used with Internet micro-browsers. Such a network computer or thin client device does not necessarily include all of the devices and features of the above-described exemplary computer system; however, the functionality of the present invention or a subset thereof may nevertheless be implemented with such devices.

A communication device 226 is also coupled to bus 216 for accessing remote computers or servers, such as web server 100, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 100 via a conventional network infrastructure such as the infrastructure illustrated in FIG. 1 and described above.

The system of the present invention includes software, information processing hardware, and various processing steps, which will be described below. The features and process steps of the present invention may be embodied in machine or computer executable instructions. The instructions can be used to cause a general purpose or special purpose processor, which is programmed with the instructions to perform the steps of the present invention. Alternatively, the features or steps of the present invention may be performed by specific hardware components that contain hard-wired logic for performing the steps, or by any combination of programmed computer components and custom hardware components. While embodiments of the present invention will be described with reference to the Internet, the method and apparatus described herein is equally applicable to other network infrastructures or other data communications systems.

The present invention is a computer-implemented system and method for obtaining information related to media content. Various embodiments of the present invention will be described below. In particular, the use of the present invention with various types of media will be described. As used herein, the term ‘media’ represents any combination of text, audio, video, graphics, photos, images, animations, ringtones, games, and/or any other type of content that can be represented in digital form.

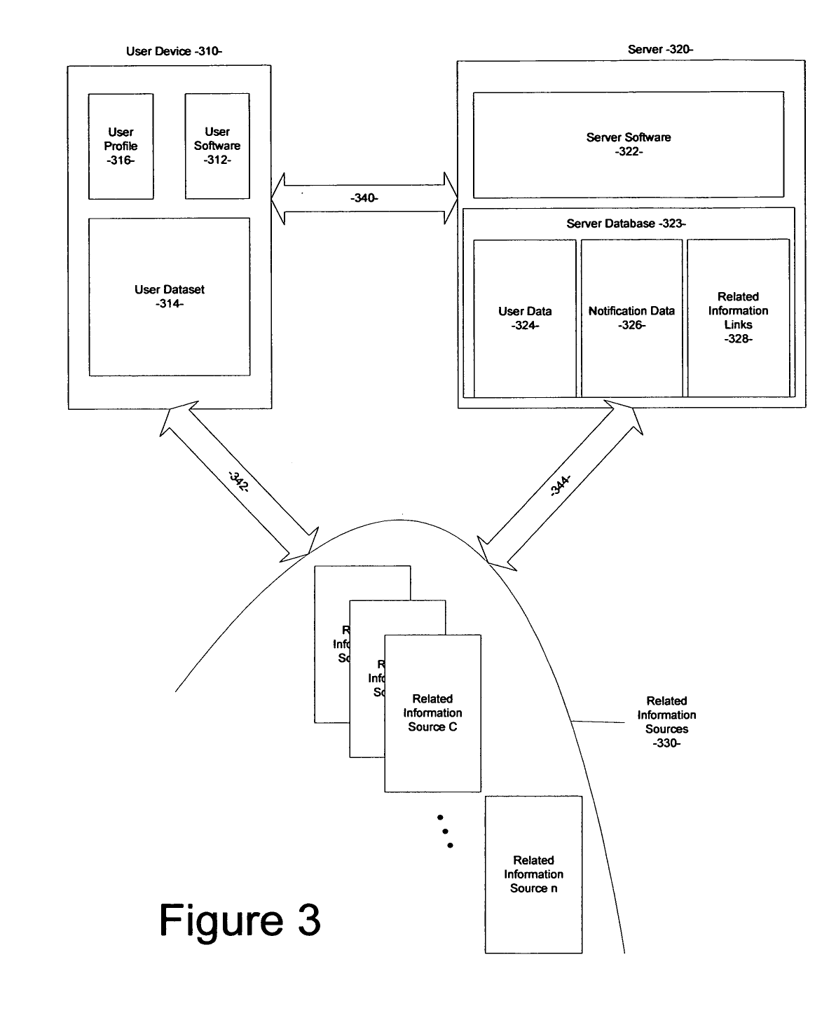

Referring now to FIG. 3, a block diagram illustrates the basic system components used by the present invention. A user device 310 is shown. User device 310 represents one of a variety of different types of available client devices such as, personal computers, personal digital assistants, robust cell phones, laptop computers, and other types of conventional personal computing devices. Many conventional user computing devices include user profile information 316. User profile information 316 includes any of a variety of user-specific demographic information either captured automatically by conventional means or explicitly entered by a user. User software 312 represents a software component that implements a portion of the methods of the present invention. The functionality and operation of user software 312 and will be described in more detail below. User dataset 314 represents a collection of media content, retained and stored on user device 310. Examples of user dataset 314 include, a collection of music files, typically encoded in the conventional MP3 format. Other examples of user dataset 314 include video libraries, digital book libraries, sets of related text documents, photo albums, graphical or animation files, etc. Conventional media content datasets typically include attribute or characteristic information related to items of the dataset. For example, in a music library, it is common for each song in the dataset to include attribute/characteristic information, including for example, artist, song title, album name, song duration, and other characteristics of the items in the dataset. It will be apparent to those of ordinary skill in the art that many other types of characteristic information may be defined and retained for each item in the dataset. In some cases, these attributes/characteristics of the media content are carried with the content itself as metadata. In other cases, the attributes/characteristics of the content must be obtained from other sources. For example, some attributes/characteristics of the content may be available with the content while other attributes/characteristics are not immediately available. The available attributes/characteristics can be used to search local or remote databases or websites for other attributes/characteristics related to the media content. Portions of the content itself can also be used to query databases or websites for related attributes/characteristics of the content. In this manner, media content items are matched with their corresponding enhanced set of attributes/characteristics. As will be described in more detail below, the characteristic information in user dataset 314 will be used by the present invention to obtain related information from external sources.

Referring again to FIG. 3, server 320 is shown in network connection with user device 310. Using conventional means, server 320 is connected to user device 310 via any of a variety of network links 340, including wired and wireless links. Server 320 includes server software 322, which includes functional code that implements a portion of the processes of the present invention as described herein. Server 320 also includes server database 323. Server database 323 is composed of parts, such as a user data component 324, a notification data component 326, and a related information links component 328. It will be apparent to those of ordinary skill in the art that a particular implementation of server database 323 may not include all of the components illustrated in FIG. 3 or such implementation may include other components not shown in FIG. 3. Nevertheless, the component parts of the present invention are defined by the claims provided herein. User data 324 is used to retain media content characteristic information for each user. Notification data 326 is used to retain information related to event notifications for each user. Related information links 328 retains information associating media content characteristic information with related information sources, corresponding to the media content characteristics. These components of the server database 323 will be described in more detail below.

FIG. 3 also shows the user device 310 and server 320 coupled to a set of related information sources 330. In one embodiment, related information sources 330 represent various web sites, which contain information related to various media content items. User device 310 and server 320 may be connected to these related information sources 330 using conventional network connections and protocols 342 and 344.

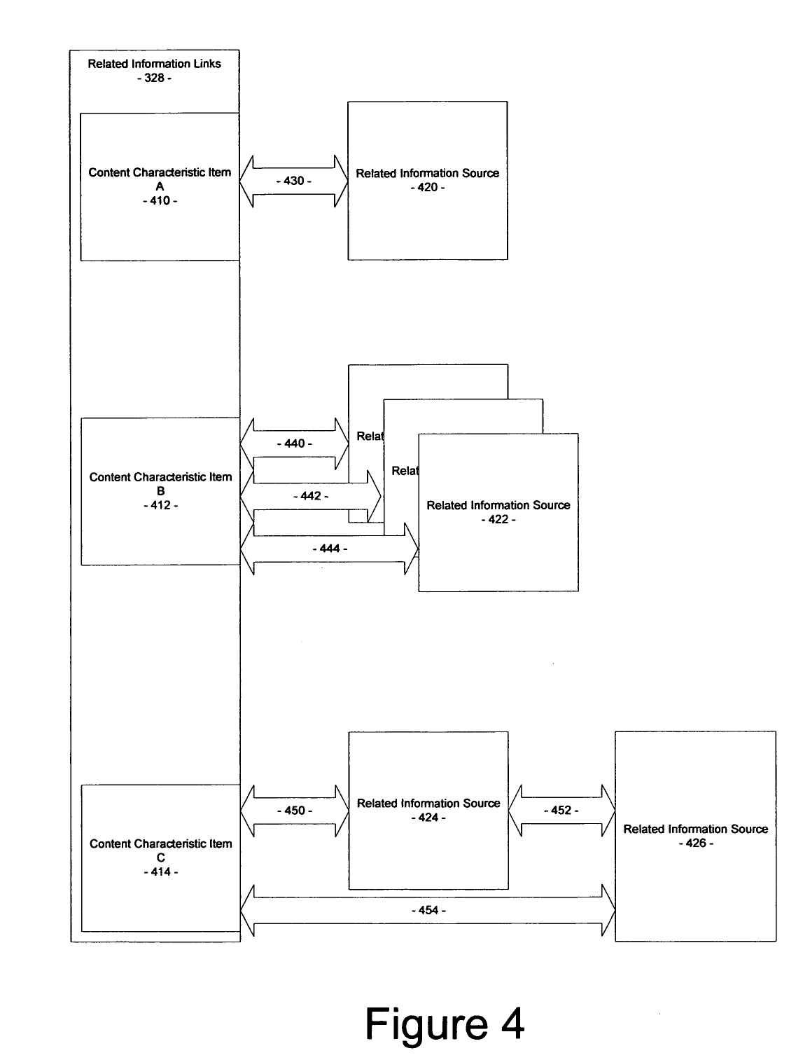

Referring to FIG. 4, related information links component 328 is illustrated in further detail. Related information links 328 includes a set of content characteristic items. A particular example of a content characteristic item is the artist/author of a particular song. Other examples of a content characteristic item include the director of a film, an actor in a film, the author of a book, a book publisher, and many other similar types of content characteristic items. Three such items are represented in FIG. 4 as item 410, item 412, and item 414. Each content characteristic item as stored in related information links 328 includes linkage information that defines the location or Web address of a related external information source. For example, for a content characteristic item that represents the artist of a song, the linkage information might define the web address of a web site associated with that particular song artist. As shown by link 430 in FIG. 4, this linkage information can be a single source pointer to a destination that defines a single related information source 420. In other cases, a single content characteristic item may have links (e.g. 440, 442, 444) to multiple related information sources 422. For example, multiple web sites may be associated with a particular song artist. As a third example of the types of linkage information retained in related information links 328, content characteristic item 414 is shown serially linked with two or more related information sources 424 and 426. In some cases, a desired source of related information may be chained through a set of multiple web sites. For example, it may be desirable to know the dates and locations of concerts featuring a particular song artist. However, it may be necessary to first access the song artist's web site to obtain the name and Web address of a promoter who sponsors concerts for that particular song artist. In this case, linkage information, 450 defines a first access to a related information source 424 and a subsequent access to a second related information source 426 through link 452. Alternatively, content characteristic item 414 can retain linkage information 454, if a direct link to a desired related information source 426 is known or becomes known.

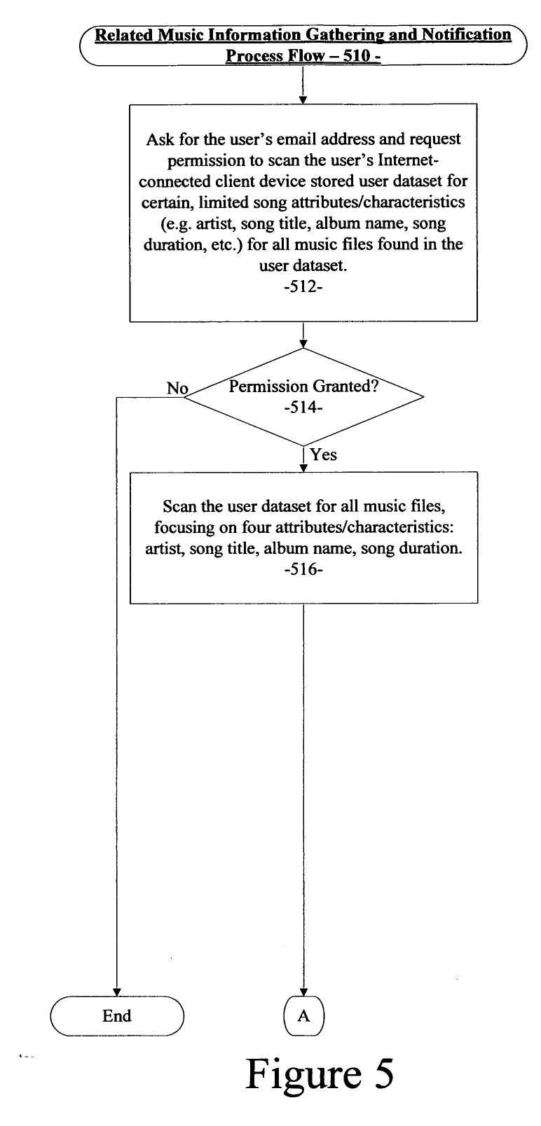

Using embodiments of the system structure described above, the present invention can obtain information related to various items of media content. Several embodiments of the present invention and various related process flows will be described below in relation to FIGS. 5-9.

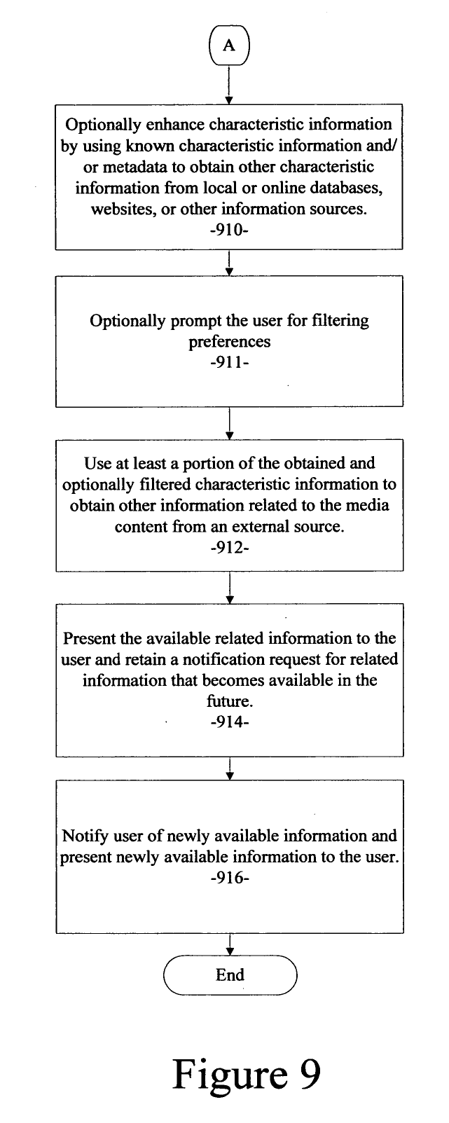

Referring to FIG. 5, the process flow 510, of one embodiment enables the present invention to gather related music information and to notify the user when new related information becomes available. In block 512, user software 312 asks the user for an e-mail address. The user e-mail address can be used to send related information to the user and to notify the user of newly available information. In block 512, user software 312 asks the user for permission to scan the user dataset 314 stored on the user's Internet-connected client device 310. If the user denies permission, processing terminates. If the user allows the scanning of user dataset 314, processing control proceeds to block 516. At block 516, user dataset 314 is scanned for all media content files on the user device 310. In this embodiment, user dataset 314 is scanned for all music files. In one embodiment, music files can be identified by the .mp3 (or .wma, .asf, .aac, .ogg, etc.) filename extension. In another embodiment, the file system will explicitly identify a file as a music file tppe. When the music files are found, the attribute/characteristic information for each music file is extracted. In one embodiment, this characteristic information is retained in the metadata for the music file. In other cases, the attributes/characteristics of the music content must be obtained from other sources. For example, some attributes/characteristics of the content may be available with the content while other attributes/characteristics are not immediately available. The available attributes/characteristics can be used to search local or remote databases or websites for other attributes/characteristics related to the media content. Portions of the content itself can also be used to query databases or websites for related attributes/characteristics of the content. In this manner, media content items are matched with their corresponding enhanced set of attributes/characteristics. This attribute/characteristic information can include the artist, song title, album name, and song duration for the track encoded in the music file. Processing in block 516 continues until the entire user dataset 314 has been scanned and corresponding media content characteristic information for the user has been extracted. Processing then continues at the bubble A shown in FIG. 9.

Referring to FIG. 9, the processing for one embodiment continues at bubble A. In block 910, the system can optionally enhance the characteristic information by using known characteristic information and/or metadata to obtain other characteristic information from local or online databases, websites, or other information sources. At block 911, the user can optionally be prompted for filtering preferences. In one embodiment, the user is prompted to choose ‘ALL’ or ‘SOME’ specific content characteristic items to be included in their related music information notification list based on the characteristic information found in their user dataset 314. In this manner, the user can filter his/her preferences for characteristic information. For example, if the content characteristic information of interest is the song artist, the user can select ‘ALL’ to include all artists found in the user dataset for inclusion into user data 324 on server 320. The user-specific data stored in user data 324 is tagged with a unique identifier assigned to that particular user. If the user selects ‘SOME’, user software 312 prompts the user to specify selected ones of the content characteristic items found in user dataset 314. For example, if the content characteristic information of interest is the song artist, the user can select ‘SOME’ to include only selected ones of the artists found in the user dataset for inclusion into user data 324 on server 320. The user data stored in user data 324 is tagged with a unique identifier assigned to that particular user. Users are still given an option to add artists onto their related musical information notification list even though the artists are not found on their user dataset 314 scan. In this manner, user device 310 and server 320 operate collaboratively to populate user data 324 on server 320 with user-specific media content characteristic information uniquely tagged for a particular user.

At block 912, at least a portion of the obtained characteristic information can be used to obtain other information related to the media content from an external source. The related information links 328 can be used for this purpose. In one embodiment, monitoring web logs, podcasts, or photos may detect emerging information, for example, about an upcoming concert tour by one of the artists on the user's related musical information notification list. Once the related information is obtained, the available related information is presented to the user in block 914. A notification request is retained for related information that becomes available in the future. When the related information becomes available in the future, the user is notified of newly available information using the retained notification request at block 916. The newly available information is then presented to the user. Processing terminates at the End bubble.

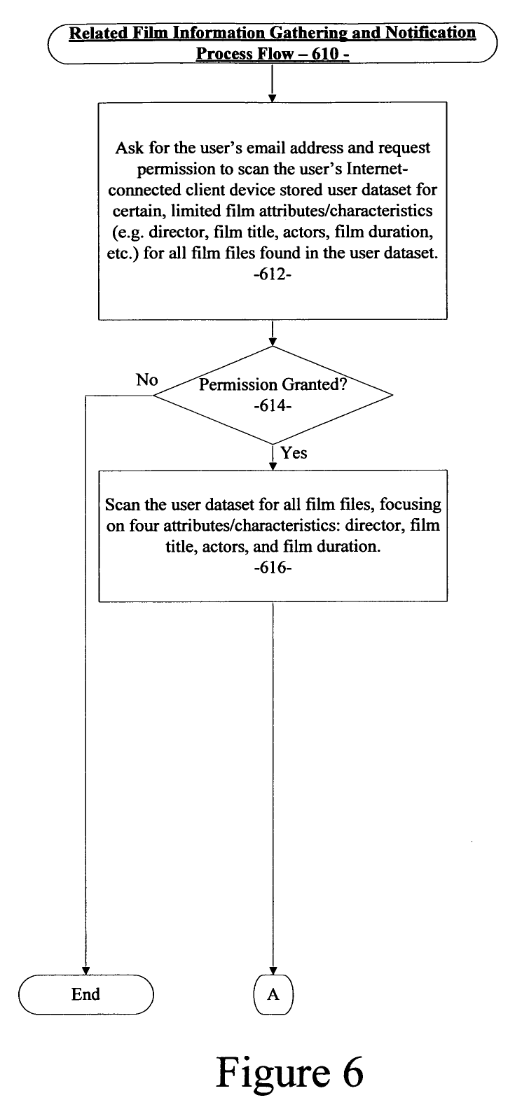

Referring to FIG. 6, the process flow 610, of one embodiment enables the present invention to gather related film or video information and to notify the user when new related information becomes available. In block 612, user software 312 asks the user for an e-mail address. The user e-mail address can be used to send related information to the user and to notify the user of newly available information. In block 612, user software 312 asks the user for permission to scan the user dataset 314 stored on the user's Internet-connected client device 310. If the user denies permission, processing terminates. If the user allows the scanning of user dataset 314, processing control proceeds to block 616. At block 616, user dataset 314 is scanned for all media content files on the user device 310. In this embodiment, user dataset 314 is scanned for all film or video files. In one embodiment, film or video files can be identified by a particular known filename extension (e.g. .vob, .asx, avi, .mov, .wmv, .asf, .divx, .ivf, .mpeg, etc). In another embodiment, the file system will explicitly identify a file as a film or video file type. When the film or video files are found, the attribute/characteristic information for each film or video file is extracted. In one embodiment, this characteristic information is retained in the metadata for the film or video file. In other cases, the attributes/characteristics of the film or video content must be obtained from other sources. For example, some attributes/characteristics of the content may be available with the content while other attributes/characteristics are not immediately available. The available attributes/characteristics can be used to search local or remote databases or websites for other attributes/characteristics related to the media content. Portions of the content itself can also be used to query databases or websites for related attributes/characteristics of the content. In this manner, media content items are matched with their corresponding enhanced set of attributes/characteristics. This attribute/characteristic information can include the director, film title, actors, film duration, etc. for the film or video content encoded in the file. Processing in block 616 continues until the entire user dataset 314 has been scanned and corresponding media content characteristic information for the user has been extracted. Processing then continues at the bubble A shown in FIG. 9.

Referring to FIG. 9, the processing for one embodiment continues at bubble A. In block 910, the system can optionally enhance the characteristic information by using known characteristic information and/or metadata to obtain other characteristic information from local or online databases, websites, or other information sources. At block 911, the user can optionally be prompted for filtering preferences. One embodiment of filtering is described above. At block 912, at least a portion of the obtained characteristic information can be used to obtain other information related to the media content from an external source. The related information links 328 can be used for this purpose. In one embodiment, monitoring web logs, podcasts, or photos may detect emerging information, for example, about an upcoming DVD film release involving one of the directors or actors on the user's related film information notification list Once the related information is obtained, the available related information is presented to the user in block 914. A notification request is retained for related information that becomes available in the future. When the related information becomes available in the future, the user is notified of newly available information using the retained notification request at block 916. The newly available information is then presented to the user. Processing terminates at the End bubble.

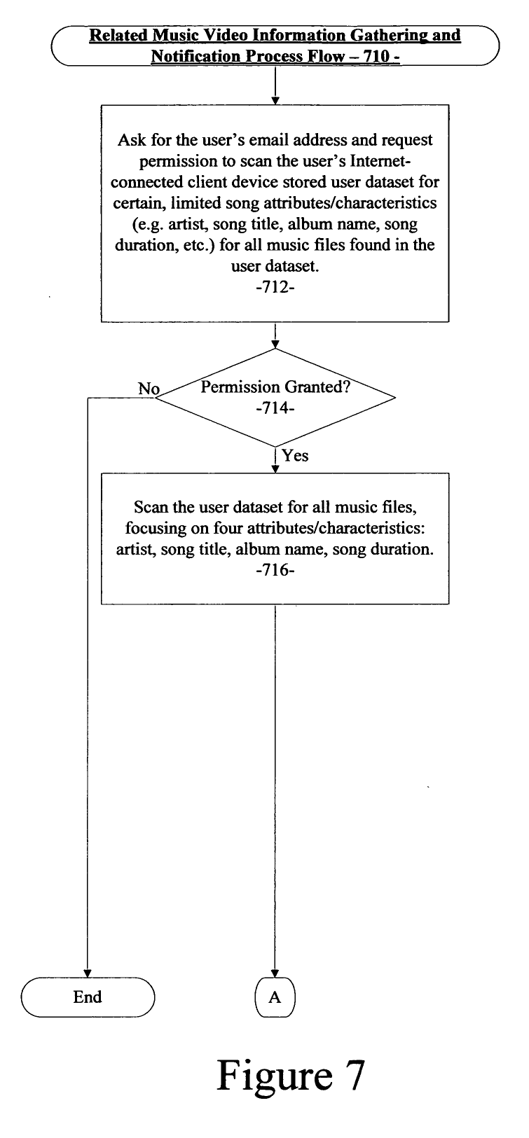

Referring to FIG. 7, the process flow 710, of one embodiment enables the present invention to gather related music video information and to notify the user when new related information becomes available. In block 712, user software 312 asks the user for an e-mail address. The user e-mail address can be used to send related information to the user and to notify the user of newly available information. In block 712, user software 312 asks the user for permission to scan the user dataset 314 stored on the user's Internet-connected client device 310. If the user denies permission, processing terminates. If the user allows the scanning of user dataset 314, processing control proceeds to block 716. At block 716, user dataset 314 is scanned for all media content files on the user device 310. In this embodiment, user dataset 314 is scanned for all music video files. In one embodiment, music video files can be identified by a particular filename extension (e.g. .qt, .mov, .wmv, avi, .ivf, .swv, .fla, .mpg, .divx, etc). In another embodiment, the file system will explicitly identify a file as a music file type. When the music video files are found, the attribute/characteristic information for each music video file is extracted. In one embodiment, this characteristic information is retained in the metadata for the music video file. In other cases, the attributes/characteristics of the music video content must be obtained from other sources. For example, some attributes/characteristics of the content may be available with the content while other attributes/chamacteristics are not immediately available. The available attributes/characteristics can be used to search local or remote databases or websites for other attributes/characteristics related to the media content. Portions of the content itself can also be used to query databases or websites for related attributes/characteristics of the content. In this manner, media content items are matched with their corresponding enhanced set of attributes/characteristics. This attribute/characteristic information can include the artist, song title, album name, and song duration for the track encoded in the music video file. Processing in block 716 continues until the entire user dataset 314 has been scanned and corresponding media content characteristic information for the user has been extracted. Processing then continues at the bubble A shown in FIG. 9.

Referring to FIG. 9, the processing for one embodiment continues at bubble A. In block 910, the system can optionally enhance the characteristic information by using known characteristic information and/or metadata to obtain other characteristic information from local or online databases, websites, or other information sources. At block 911, the user can optionally be prompted for filtering preferences. One embodiment of filtering is described above. At block 912, at least a portion of the obtained characteristic information can be used to obtain other information related to the media content from an external source. The related information links 328 can be used for this purpose. In one embodiment, monitoring web logs, podcasts, or photos may detect emerging information, for example, about live footage to be captured on video from an upcoming concert by one of the artists on the user's related musical information notification list. Once the related information is obtained, the available related information is presented to the user in block 914. A notification request is retained for related information that becomes available in the future. When the related information becomes available in the future, the user is notified of newly available information using the retained notification request at block 916. The newly available information is then presented to the user. Processing terminates at the End bubble.

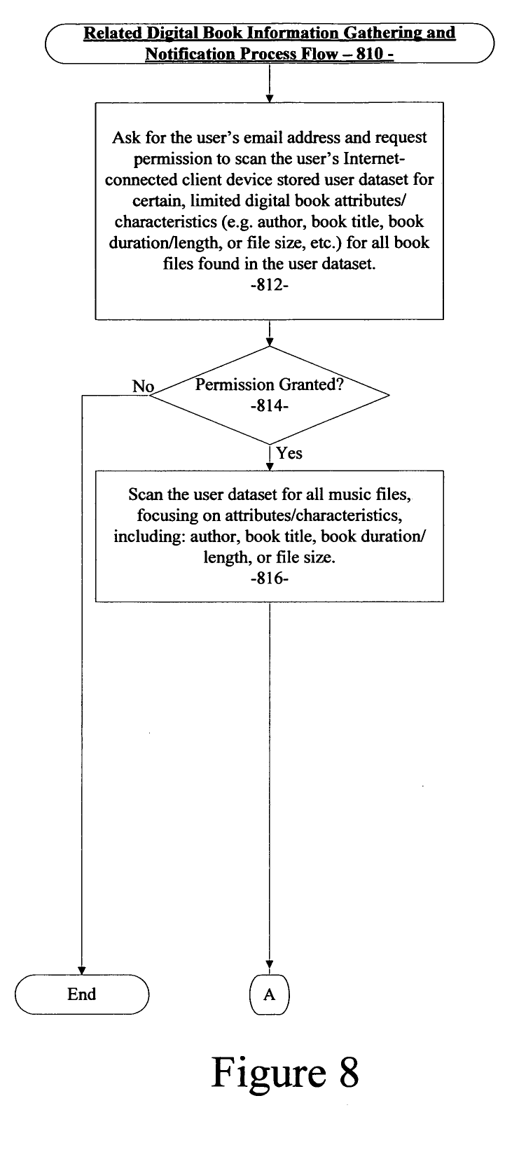

Referring to FIG. 8, the process flow 810, of one embodiment enables the present invention to gather related digital book information and to notify the user when new related information becomes available. In block 812, user software 312 asks the user for an e-mail address. The user e-mail address can be used to send related information to the user and to notify the user of newly available information. In block 812, user software 312 asks the user for permission to scan the user dataset 314 stored on the user's Internet-connected client device 310. If the user denies permission, processing terminates. If the user allows the scanning of user dataset 314, processing control proceeds to block 816. At block 816, user dataset 314 is scanned for all media content files on the user device 310. In this embodiment, user dataset 314 is scanned for all digital book files. In one embodiment, digital book files can be identified by a particular filename extension (e.g. for electronic book files, .pdf, .pdb, .oeb, .rb, .txt, .htm, .rtf, .doc, .lit, and for audio book files, .mp3, .wav, .aiff, .wma). In another embodiment, the file system will explicitly identify a file as a digital book file type. When the digital book files are found, the attribute/characteristic information for each digital book file is extracted. In one embodiment, this characteristic information is retained in the metadata for the digital book file. In other cases, the attributes/characteristics of the music content must be obtained from other sources. For example, some attributes/characteristics of the content may be available with the content while other attributes/characteristics are not immediately available. The available attributes/characteristics can be used to search local or remote databases or websites for other attributes/characteristics related to the media content. Portions of the content itself can also be used to query databases or websites for related attributes/characteristics of the content. In this manner, media content items are matched with their corresponding enhanced set of attributes/characteristics. This attribute/characteristic information can include the author, book title, book duration/length, or file size, etc. for the digital book content encoded in the digital book file. Processing in block 816 continues until the entire user dataset 314 has been scanned and corresponding media content characteristic information for the user has been extracted. Processing then continues at the bubble A shown in FIG. 9.

Referring to FIG. 9, the processing for one embodiment continues at bubble A. In block 910, the system can optionally enhance the characteristic information by using known characteristic information and/or metadata to obtain other characteristic information from local or online databases, websites, or other information sources. At block 911, the user can optionally be prompted for filtering preferences. One embodiment of filtering is described above. At block 912, at least a portion of the obtained characteristic information can be used to obtain other information related to the media content from an external source. The related information links 328 can be used for this purpose. In one embodiment, monitoring web logs, podcasts, or photos may detect emerging information, for example, about an upcoming speaking tour by one of the authors on the user's related book information notification list. Once the related information is obtained, the available related information is presented to the user in block 914. A notification request is retained for related information that becomes available in the future. When the related information becomes available in the future, the user is notified of newly available information using the retained notification request at block 916. The newly available information is then presented to the user. Processing terminates at the End bubble.

Referring again to FIG. 3, server software 322 can use the media content characteristic information from user data 324 in search queries on the World Wide Web using conventional search tools, such as Google. These search queries can produce links to related information sources 330. Links to these sources 330 are maintained in related information links 328 in association with the media content characteristic information that produced the corresponding search results. In this manner, server 320 can produce and maintain a large set of related information sources corresponding to media content characteristic information. Periodically, server 320 can re-execute searches of the related information sources and determine if the related information and related links have changed. If the related information and/or related links have changed, users can be notified using information stored in notification data 326.

Using the techniques described above, the present invention enables one to obtain a variety of information related to various forms of media content. Referring again to FIG. 5, the present invention enables the gathering of related information such as:

1. Concert Tour information (dates, locations, ticket availability) by the Artist:
Collaborate with Artists' web site masters to publish concert dates, locations and ticket purchasing options using Real Simple Syndication (RSS) feeds.
As a default, go to Pollstar.com and use their search results for the Artist's tour information; if Pollstar.com does not have the Artist listed, then go check the Artist's web site for tour information.

2. Music Videos by the same Artist, of the same song:
As a default, go to Amazon.com and use their search results for the Artist's VHS & DVD information; if Amazon.com does not have the Artist listed, then go check the Artist's web site for Music Video availability (for either purchase or online viewing).

3. New Albums released by the Artist:
As a default, go to Amazon.com and use their search results for the Artist's new music release information; if Amazon.com does not have the Artist listed, then go check the Artist's web site for new music release availability (for either purchase or online viewing).

4. Other Albums, Extended Play Albums, or Singles released by the Artist:
As a default, go to Amazon.com and use their search results for the Artist's music catalog information; if Amazon.com does not have the Artist listed, then go check the Artist's web site for music catalog availability (for either purchase or online viewing).

5. Other Versions of the Song in the user dataset by the same Artist:

6. Other Versions of the Song in the user dataset by a different Artist:

7. Ringtones of the Song

Referring again to FIG. 6, the present invention enables the gathering of related information such as:

1. Festival & Premiere screening information (dates, locations, ticket availability) for films by the directors and actors:
Collaborate with directors' and actors' web site masters to publish Festival & Premiere screening dates, locations and ticket purchasing options using Real Simple Syndication (RSS) feeds
As a default, go to film industry websites and use their search results for the directors' and actors' Festival & Premiere screening information.

2. DVD/VHS, Satellite or Internet release information (dates, locations) for films by the directors and actors:
Work with distributors (Blockbuster, NetFlix, Revelations Entertainment, Dish Network, DirectTV) to publish DVD/VHS, Satellite or Internet film release information (dates, locations).

3. Music Soundtrack for the film.

4. Other films released by the directors or actors.

5. Other versions of the same film title in the user dataset by different directors and actors.

6. Other remakes of the film title in the user dataset by different directors and actors:

Referring again to FIG. 7, the present invention enables the gathering of related information such as:

1. Concert Tour information (dates, locations, ticket availability) by the Artist:
Collaborate with Artists' web site masters to publish concert dates, locations and ticket purchasing options using Real Simple Syndication (RSS) feeds
As a default, go to Pollstar.com and use their search results for the Artist's tour information; if Pollstar.com does not have the Artist listed, then go check the Artist's web site for tour information.

2. Music Videos by the same Artist, of the same song:
As a default, go to Amazon.com and use their search results for the Artist's VHS, DVD, and/or PC-compatible music video player information; if Amazon.com does not have the Artist listed, then go check the Artist's web site for Music Video availability (for either purchase or online viewing).

3. New Albums released by the Artist:
As a default, go to Amazon.com and use their search results for the Artist's new music release information; if Amazon.com does not have the Artist listed, then go check the Artist's web site for new music release availability (for either purchase or online viewing).

4. Other Albums, Extended Play Albums, or Singles released by the Artist:
As a default, go to Amazon.com and use their search results for the Artist's music catalog information; if Amazon.com does not have the Artist listed, then go check the Artist's web site for music catalog availability (for either purchase or online viewing).

5. Other Versions of the Song in the user dataset by the same Artist:

6. Other Versions of the Song in the user dataset by a different Artist:

7. Ringtones of the song.

Referring again to FIG. 8, the present invention enables the gathering of related information such as:

1. Speech and Book Tour information (dates, locations, ticket availability) by the author:
Work with Author's web site masters to publish Speech and Book Tour dates, locations and ticket purchasing options using Real Simple Syndication (RSS) feeds.
As a default, go to performance industry websites and use their search results for the Author's tour information.

2. Other books (paper, audio, and electronic) released by the Author.

3. Other media products by the Author.

Thus, a computer-implemented system and method for obtaining information related to media content is disclosed. While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A computer-implemented method comprising:
inspecting a user dataset to obtain a list of media content items;
extracting characteristic information and metadata from media content items;
optionally enhancing metadata by obtaining more metadata based on the characteristic information;
optionally obtaining filtering preferences from the user; and
using at least a portion of the content metadata and the filtering preferences to obtain related information from an external source.

2. A computer-implemented method comprising:
inspecting a user dataset to obtain a list of media content items;
extracting characteristic information and metadata from media content items;
optionally enhancing metadata by obtaining more metadata based on the characteristic information;
optionally obtaining filtering preferences from the user;
using at least a portion of the content metadata and the filtering preferences to obtain related information from an external source;
presenting available related information to the user; and
retaining a notification request for related information that becomes available in the future and presenting newly-available related information.

3. A computer-implemented method comprising:
inspecting a user dataset to obtain a list of media content items;
extracting characteristic information and metadata from media content items;
optionally enhancing metadata by obtaining more metadata based on the characteristic information;
optionally obtaining filtering preferences from the user; and
using at least a portion of the content metadata and the filtering preferences to obtain related media content information from an external source, wherein said related media content information has at least one element in common with the content metadata.

4. A computer-implemented method comprising:
inspecting a user dataset to obtain a list of media content items;
extracting characteristic information and metadata from media content items;
optionally enhancing metadata by obtaining more metadata based on the characteristic information;
optionally obtaining filtering preferences from the user;
using at least a portion of the content metadata and the filtering preferences to obtain related information from an external source, wherein said related information has at least one element in common with the content metadata;
presenting available related information to the user; and
retaining a notification request for related information that becomes available in the future and presenting newly-available related information.

5. The method as claimed in claim 1 wherein the media content items comprise music, video, or digital book content.

6. The method as claimed in claim 1 wherein the media content items characteristic information comprises artist, song title, album name, and song duration.

7. The method as claimed in claim 1 wherein the media content item characteristic information comprises film title, director, actor names, and film duration.

8. The method as claimed in claim 1 wherein the media content item characteristic information comprises author, title, and content length.

9. The method as claimed in claim 3 wherein the related media content information comprises artist concert tour information, music videos by the same artist, albums by the same artist, other versions of a song by the artist, or ringtones of the song.

10. The method as claimed in claim 3 wherein the related media content information comprises film screening information, film release information, film music soundtrack, other films by the same director, other films by the same actors, other versions of the film, other media by the same director, or other media by the same actors.

11. The method as claimed in claim 3 wherein the related media content information comprises book tour information, book release information, other books by the same author, other media by the same author.

12. The method as claimed in claim 1 wherein the related information comprises artist concert tour information, music videos by the same artist, albums by the same artist, other versions of a song by the artist, or ringtones of the song.

13. The method as claimed in claim 1 wherein the related information comprises film screening information, film release information, film music soundtrack, other films by the same director, other films by the same actors, other versions of the film, other media by the same director, or other media by the same actors.

14. The method as claimed in claim 1 wherein the related information comprises book tour information, book release information, other books by the same author, other media by the same author.

15. The method as claimed in claim 1 wherein the related information is obtained using information from web logs, podcasts or photos.

16. The method as claimed in claim 3 wherein the media content items comprise music, video, or digital book content.

17. The method as claimed in claim 3 wherein the media content items characteristic information comprises artist, song title, album name, and song duration.

18. The method as claimed in claim 3 wherein the media content item characteristic information comprises film title, director, actor names, and film duration.

19. The method as claimed in claim 3 wherein the media content item characteristic information comprises author, title, and content length.

20. The method as claimed in claim 3 wherein the related media content information is obtained using information from web logs, podcasts, or photos.

21. An apparatus having software processing logic that when executed by a data processor causes the apparatus to perform actions comprising:
inspecting a user dataset to obtain a list of media content items;
extracting characteristic information and metadata from media content items;
optionally enhancing metadata by obtaining more metadata based on the characteristic information;
optionally obtaining filtering preferences from the user; and
using at least a portion of the content metadata and the filtering preferences to obtain related information from an external source.

22. An apparatus having software processing logic that when executed by a data processor causes the apparatus to perform actions comprising:
inspecting a user dataset to obtain a list of media content items;
extracting characteristic information and metadata from media content items;
optionally enhancing metadata by obtaining more metadata based on the characteristic information;
optionally obtaining filtering preferences from the user;
using at least a portion of the content metadata and the filtering preferences to obtain related information from an external source;
presenting available related information to the user; and
retaining a notification request for related information that becomes available in the future and presenting newly-available related information.
